(19) United States
(12) Patent Application Publication
(10) Pub. No.: US 2023/0198763 A1
(43) Pub. Date: Jun. 22, 2023

(54) SYSTEM AND METHOD FOR ASSOCIATING A NON-FUNGIBLE TOKEN (NFT) WITH A NETWORK DEVICE

(71) Applicant: Pollen Mobile LLC, San Franscisco, CA (US)

(72) Inventors: Anthony LEVANDOWSKI, San Francisco, CA (US); Oscar ARGUETA, San Francisco, CA (US); Alexander CHAN, San Francisco, CA (US); Catherine CULKIN, San Francisco, CA (US); Kemal FICCI, San Francisco, CA (US); Sridatta KOMPELLA, San Francisco, CA (US); Christian KURASEK, San Francisco, CA (US); Thomas MULROY, San Francisco, CA (US); Ryan OZAWA, San Francisco, CA (US); Andrew STEPHENS, San Francisco, CA (US); Anya ZAYTSEVA, San Franscisco, CA (US)

(21) Appl. No.: 18/145,848

(22) Filed: Dec. 22, 2022

Related U.S. Application Data
(60) Provisional application No. 63/265,887, filed on Dec. 22, 2021.

(51) Int. Cl. H04L 9/32

(52) U.S. Cl. CPC H04L 9/3213; H04L 2209/60

(57) ABSTRACT

An anonymous, decentralized, high speed, open source, data-only, wireless network is deployed in physical space. A server attached to the network generates a Non-Fungible Token (NFT) and associates the NFT with a first network device (e.g., a cellular antennae) before the first network device is deployed in the cellular network. After deployment of the first network device into the cellular network, a second network device (e.g., a network validator) can identify the first network device with information from the NFT. In this way, a digital token can identify a physical piece of hardware for communications within the cellular network.

### CROSS REFERENCE TO RELATED APPLICATIONS

This Application claims priority to U.S. Provision Application 63/265,887, filed Dec. 22, 2021, entitled “Distributed Mobile Network,” which is incorporated herein by reference in its entirety for all that it teaches and for all purposes.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes generating a Non-Fungible Token (NFT) and the method includes associating, by a server processor, the NFT with a first network device. The method also includes identifying, by a second network device, the first network device with information from the NFT. Other embodiments of this aspect include corresponding computer systems, apparatus, computer-readable medium, and computer programs recorded on one or more computer storage devices, each configured to perform the actions of the methods.

Implementations may include one or more of the following features. The method where the NFT may include one or more of an identifier, a pseudonym, and/or deed information. The NFT further may include model or version information for the first network device. The NFT is stored at the first network device. The method may include transmitting the pseudonym from the first network device to the second network device. The first network device is a cellular antenna. The second network device is a network validator. The network validator is a stand-alone device or an application executing on a mobile device. An identity of an owner of the first network device is unknown to the second network device. An identity of the owner of the first network device is stored in a blockchain. Implementations of the described techniques may include hardware, a method or process, or computer software on a computer-readable medium.

Another general aspect includes a first network device communicating with a second network device. The method also includes the first network device sending information from an NFT to the second network device. The method also includes identifying, by the second network device, the first network device with the information from the NFT. The method also includes the second network device measuring a performance characteristic/metric of the first network device. The method also includes reporting, by the second network device, the performance metric to a server, where the information from the NFT identifies the performance metric being associated with the first network device. Other embodiments of this aspect include corresponding computer systems, apparatus, computer-readable medium, and computer programs recorded on one or more computer storage devices, each configured to perform the actions of the methods.

Implementations may include one or more of the following features. The method where the information from the NFT may include one or more of an identifier, a pseudonym, deed information, model information, and/or version information for the first network device. The performance metric is one or more of a signal coverage of an area, a ping speed, a bandwidth provided, a signal-to-noise ratio (SNR), a signal strength, and/or a latency. The method may include storing, by the second network device, a log over a period of time. The performance metric is stored periodically in the log during the period of time. The method may include determining, by the server, a benefit of the performance metric compared to a performance of other devices in a network. The method may include rewarding an owner of the NFT based on the benefit. A reward for the benefit is an amount of digital currency awarded to the owner of the NFT. Implementations of the described techniques may include hardware, a method or process, or computer software on a computer-accessible medium.

Another general aspect includes representing physical space as an array of two or more cells. The method also includes determining if network coverage is established for a first cell. The method also includes creating an incentive to motivate deployment of a first network device to provide network coverage in the first cell. The method also includes determining network coverage has been established for a first cell. The method also includes providing the incentive to an owner of the first network device. Other embodiments of this aspect include corresponding computer systems, apparatus, computer-readable medium, and computer programs recorded on one or more computer storage devices, each configured to perform the actions of the methods.

Implementations may include one or more of the following features. The method where each cell has a hexagonal shape. The array forms a honeycomb shape. The method may include generating a map to represent the array on a user interface. The incentive is provided in the map in a map representation of the first cell. Determining network coverage may include a second network device communicating with the first network device while the second network device is located in the first cell. The network coverage is determined for the first network device periodically during a period of time. The incentive is provided when the network coverage covers the period of time. The incentive is a payment of a digital currency to the owner of a non-fungible token (NFT) associated with the first network device. Implementations of the described techniques may include hardware, a method or process, or computer software on a computer-accessible medium.

### BRIEF DESCRIPTION OF THE DRAWINGS

FIG. 1A depicts a representation of an environment in which an anonymous, decentralized, high speed, open source, data-only, wireless network may be deployed in accordance with embodiments of the present disclosure.

FIG. 1B is a visual representation of a computing system having a user interface showing a representation of a map of an array of cells, as shown in FIG. 1A, in accordance with embodiments of the present disclosure.

FIG. 1C is a visual representation of a computing system having a user interface showing a representation of a cell, shown in FIG. 1A, in accordance with embodiments of the present disclosure.

FIG. 2 is a visual representation of a part of the cellular array showing different systems or components of the network in accordance with embodiments of the present disclosure.

FIG. 3A depicts a configuration of a first network device in accordance with embodiments of the present disclosure.

FIG. 3B depicts a configuration of a second network device in accordance with embodiments of the present disclosure.

FIG. 3C is a block diagram that depicts representations of processes or other functions that may be executed in hardware and/or software of the network in accordance with embodiments of the present disclosure.

FIG. 3D is another block diagram that depicts representations of processes or other functions that may be executed in hardware and/or software of the network in accordance with embodiments of the present disclosure.

FIG. 4A depicts a data structure that may be stored, retrieved, communicated, etc., within the network in accordance with embodiments of the present disclosure.

FIG. 4B depicts a data structure that may be stored, retrieved, communicated, etc., within the network in accordance with embodiments of the present disclosure.

FIG. 4C depicts a data structure that may be stored, retrieved, communicated, etc., within the network in accordance with embodiments of the present disclosure.

FIG. 4D depicts a data structure that may be stored, retrieved, communicated, etc., within the network in accordance with embodiments of the present disclosure.

FIG. 4E depicts a data structure that may be stored, retrieved, communicated, etc., within the network in accordance with embodiments of the present disclosure.

FIG. 4F depicts a data structure that may be stored, retrieved, communicated, etc., within the network in accordance with embodiments of the present disclosure.

FIG. 5 depicts a signaling diagram that represents the systems and/or communication signals that may be communicated within the network in accordance with embodiments of the present disclosure.

FIG. 6 depicts a method for identifying a network device with an NFT in accordance with embodiments of the present disclosure.

FIG. 7 depicts a method for attributing rewards to the performance of a network device identified by a NFT in accordance with embodiments of the present disclosure.

FIG. 8 depicts a method for attributing an incentive to the performance of a network device in a cell and as identified by a NFT in accordance with embodiments of the present disclosure.

FIG. 9 is a representation of computing system in accordance with embodiments of the present disclosure.

### DETAILED DESCRIPTION

Embodiments of the present disclosure will be described in connection with a network, e.g., an anonymous, decentralized, high speed, open source, data-only, wireless network. A general aspect includes generating an NFT, by a server processor, and associating the NFT with a first network device (e.g., a cellular antennae) before the first network device is deployed in the cellular network. After deployment of the first network device into the cellular network, a second network device (e.g., a network validator) can identify the first network device with information from the NFT. In this way, a digital token can identify a physical piece of hardware for communications within the cellular network.

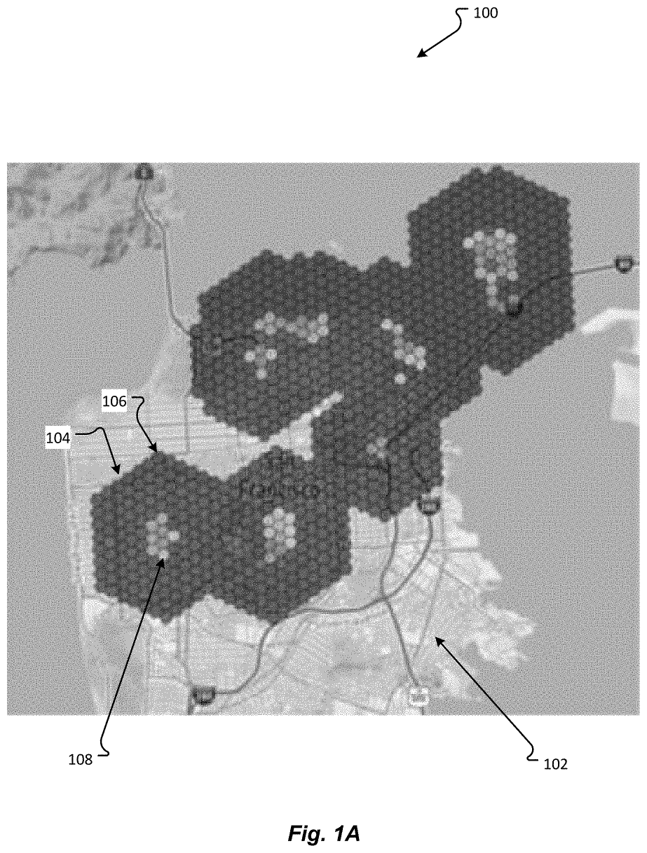

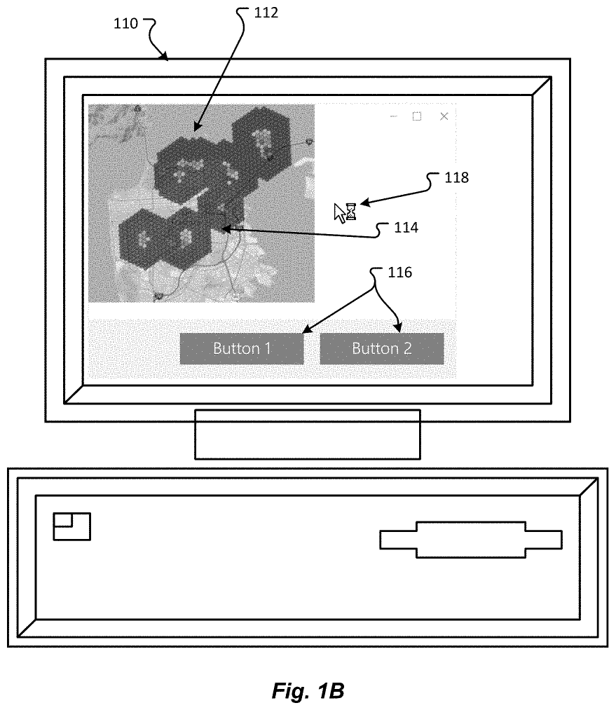

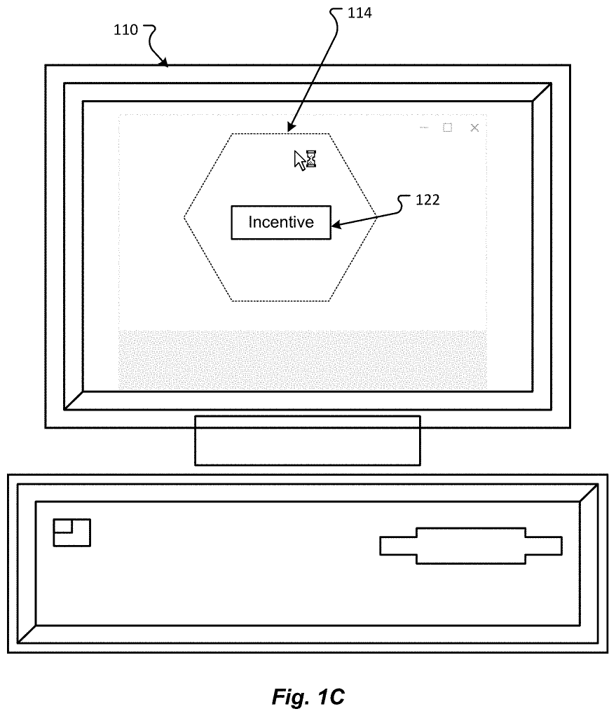

FIG. 1A depicts a representation of an environment 100 in which the wireless network may be deployed in accordance with embodiments of the present disclosure. The environment 100 can include the physical space 102 where the network devices may be deployed. Physical space 102 can include any geographical space where humans may dwell. For example, the physical space 102 can include any human-built environment or other physical features of buildings and infrastructure where the cellular service may be deployed. The physical space 102 can also include any natural features of the environment, for example, fields, mountains, forests, etc. Physical space 102 can also include the geographical space, which may be considered as land.

An array 104 of two or more cells (e.g., network nodes) 106/108 may be logically deployed within the physical space 102. The array 104 can include two or more cells, where the cells are shaped in a geometric pattern, e.g., a hexagon, and the array 104 nests these shapes to maximize coverage, e.g., in a honeycomb shape. Thus, in at least some configurations, the array 104 may have a honeycomb shape with cells 106 having a hexagon shape. The array 104 and cells 105/108 may be a geospatial representation of at least a portion of the physical space 102.

The cell representation 106/108 and the array representation 104 can have a predetermined location, perimeter, and/or area. Thus, the cells 106/108 can cover specific portions of the physical space 102 and provide for segmenting or partitioning physical space 102 into areas where the systems herein can determine whether cellular coverage is provided in an area of physical space, that is, in the cell 106/108. For example, some cells 106 may have no network coverage, which are represented in FIG. 1A with a darker color/shade. The cell 108 may have network coverage and can be represented by a lighter color or shade. Any type of visual indicia may be used to represent whether network coverage is provided within the cell 106.

In some configurations, the array 104 may be the predetermined geospatial hexagons defined by Uber's H3 Hierarchical Special Index. The H3 Hierarchical Special Index was originally developed to provide routing vehicles but is deployed here for different purposes. The array 104 may be further arranged into larger hexagons (including two or more cells 106) shown in FIG. 1A. At least a portion of the cells 106 can include a Radio Access Node (RAN) to provide network coverage within one or more cells 106.

FIG. 1B is a visual representation of a computing system having a user interface 110 showing a representation of a map 112 of the array 104 of cells 106 provided in FIG. 1A. The user interface 110 can include a window arranged into one or more different portions. The user interface window may include the map 112 displaying a visual representation of the array of cells 114. A map is a symbolic depiction emphasizing relationships between elements of some space, such as objects, regions, or themes. Map 112 may be dynamic and/or interactive. Map 112 can represent the physical space 102, without regard to context or scale. The physical space 102 may be shown as two dimensional but is three-dimensional. The map 112 is displayed in a user interface 110 of a computer, and map 112 may include Geographic Information Systems (GIS) information. The map 112 can visually represent the location and properties of geographic phenomena using map symbols, graphical depictions composed of several visual variables, such as size, shape, color, and pattern.

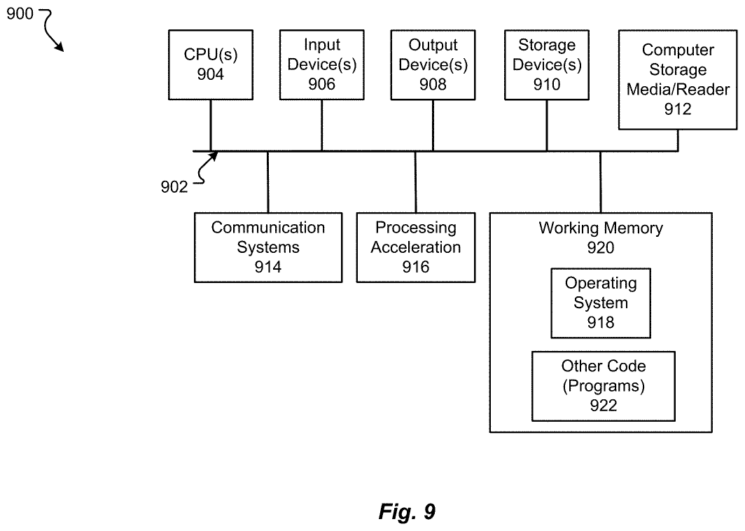

Further, the user interface 110 can include user input devices (e.g., graphical elements) 118 and 116 that allow for the input from user hardware input devices (e.g., mice, touchscreens, keyboards, etc.). The graphical elements may be as described in conjunction FIG. 9 and allow a user to maneuver a cursor 118 or other user input device in the user interface 110 and to select selectable graphical elements, e.g., buttons 116, within the user interface 110. For example, the cursor 118 may select buttons 116 or may select a cell 114 within the user interface 110. Upon selecting the appropriate graphical element, e.g., the cell 114, the user interface may change to that shown in FIG. 1C.

FIG. 1C is a visual representation of a cell 114 that may be presented after the cell 114 was selected in a user interface 110. FIG. 1C depicts a visual representation of the computing system shown in FIG. 1A with a change to the user interface 110 provided in response to a selection of a cell 114 by user input device 118 and FIG. 1B. The user interface 110 can be changed to provide a visual representation of a single cell 114, which may be related to cell 114 in FIG. 1B. The cell representation 114 may include further information, for example, information about an incentive 122. The incentive 122 can be some type of information about a reward or other type of monetary or financial benefit provided to an owner of a RAN in the cell 114 if cellular coverage is provided within the cell 114. The incentive can be an amount of digital currency or other type of reward provided if a user deploys a cellular antenna within cell 114 for some period of time.

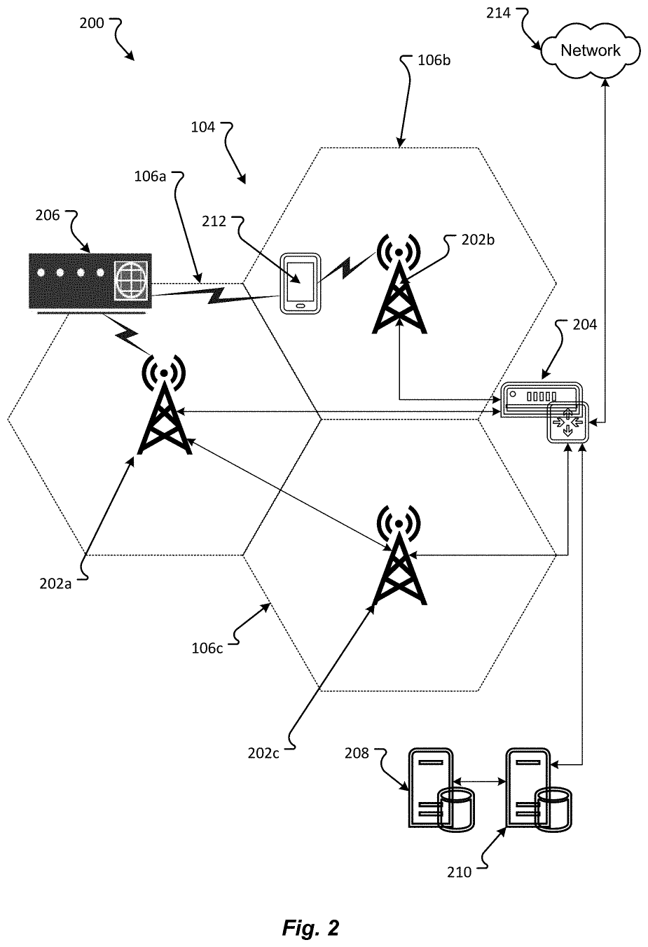

FIG. 2 is a visual representation of a portion of the cellular array 104 showing different systems or components of the network 200. The portion of the array 104 shown in FIG. 2 may include three cells 106a through 106c. Each cell 106 may include a first network device 202, for example, a RAN (a deployed cellular antenna) 202a, 202b, and/or 202c. These RANs 202 can be an EnodeB (EnB) for 4G Long-Term Evolution (LTE) coverage and/or a GnodeB (GnB) for 5G coverage. The RAN nodes 202 may be simply referred to as nodes 202 or as the first network device 202. Each node 202 may be a different type of cellular equipment and may provide different area of coverage, may provide different amounts of available bandwidth, and/or provide different cellular Quality Of Signal (QOS) or other signal parameters.

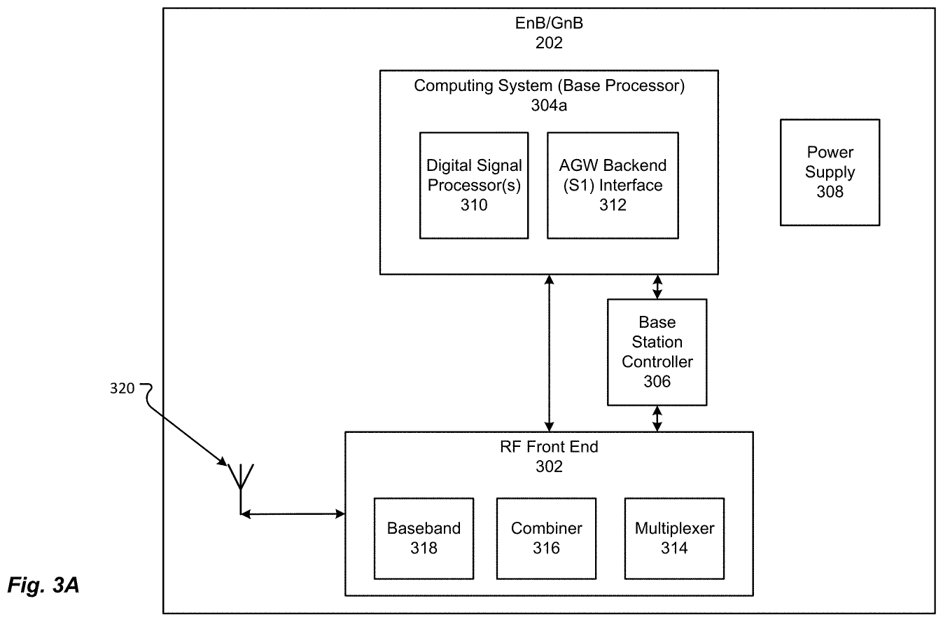

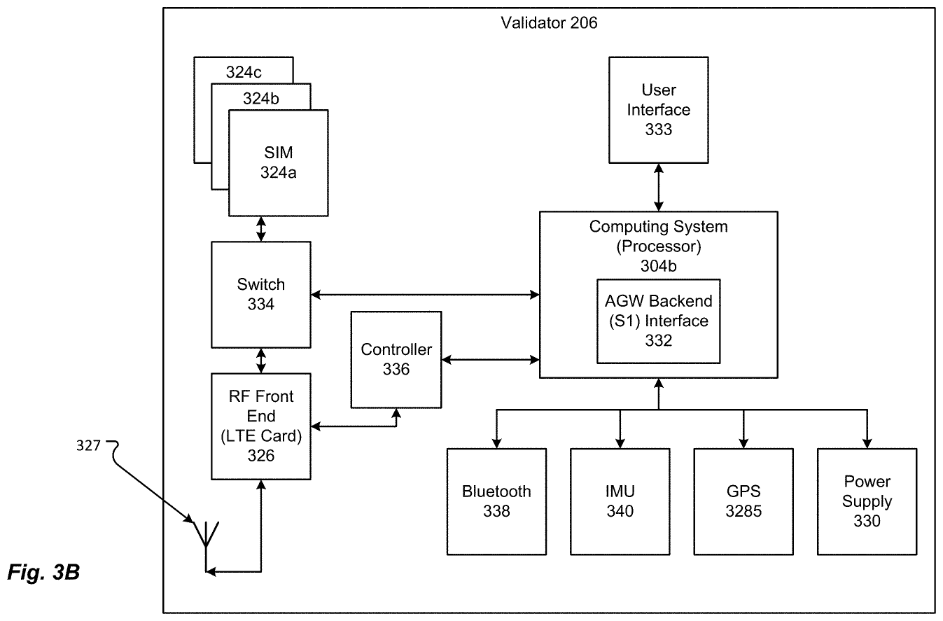

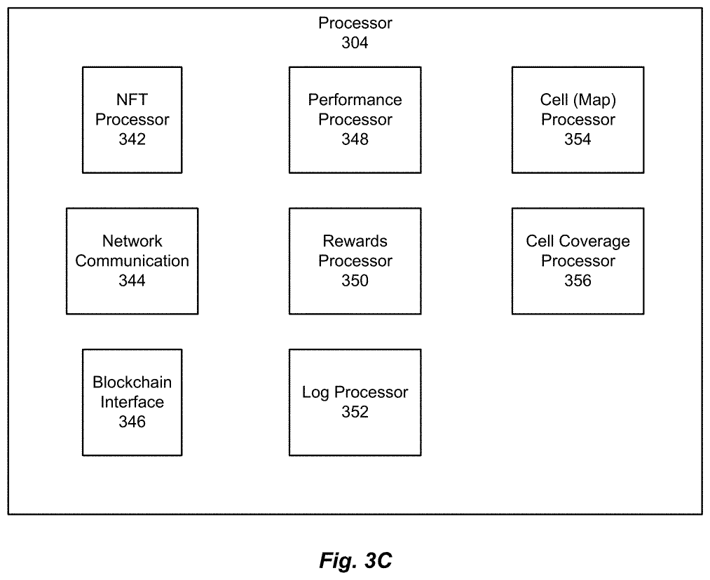

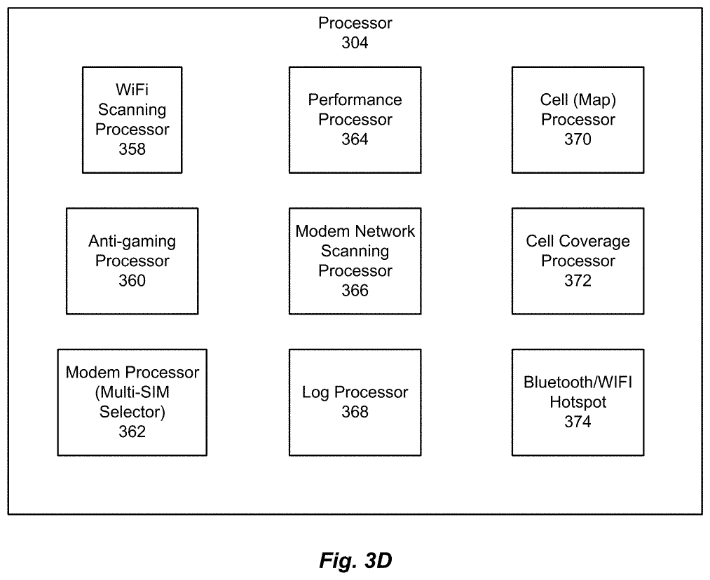

A configuration of the first network device 202, e.g., nodes or cellular antennae, may be as described in conjunction with FIG. 3A. Each cellular antenna, i.e., each first network device 202, may communicate with other cellular antennas 202 in cells 106/108 that are within physical proximity. Further, the cellular antennas 202 may communicate with a back-end Access Gateway (AGW) and/or a core network (mutually represented as system(s) 204) that may provide the network core and other functionality. Each of the core 204 functions may be deployed in a server or other computing system, as is described in conjunction FIG. 9. The core system 204 can communicate with a backend server(s) 210, which can communicate with a blockchain servers 208, both of which may help to provide functionality and/or the incentives, as described herein. Further, each first network device 202 may be communicating with or communicated with a second network device 206, also referred to as a network validator or validator 206.

The validator 206 can determine whether the first network device 202 is providing cellular coverage within a cell 106. A configuration of the second network device 206 may be as described in conjunction with FIG. 3B. The validator 206 can provide both an indication of coverage from an antenna 202 in a cell 106 and can provide network access through the antenna 202. In at least some configurations, the first network device 202 and the second network device 206 develop a wireless link that allows the second network device to both validate coverage in the cell 106 by the antenna 202 and for the second network device 206 to provide Internet access to a user equipment (UE) 212 as a hotspot or access point. UE 212 may contact or communicate with the antenna 202b (or to the validator 206 and on to the antenna 202a) through a wireless data network link. The UE communications, from the UE 212, can be sent from the node 202a/202b to the AGW 204 and then into the backhaul networks and systems 214.

The nodes 202 can communicate with each other to do hand-offs or other network administrative functions. These functions may be conducted by the nodes 202 rather than a central system, e.g., the gateway systems 204. As such, the antennas 202 can form an independent and distributed network. The backend server 210 and the blockchain server 208 may be computing devices as described in conjunction with FIG. 9. The network 214 can be all backhaul and other systems and networks, e.g., the Internet, etc.

In at least some configurations, the validator 206 is unaware of the owner of the antenna 202. In other words, the node 202 does not provide any information to the validator 206 that could be used to identify the entity that owns the antenna 202 and is providing network access. Rather, the first network device 202 (and the second network device 206) can be identified by information within an NFT. The NFT information is shared with the validator 206, which also means there is no need to provide identity information back to the gateway server 204 or backend server 210. The NFT information allows the backend server 210 to provide rewards and incentives to the owner of the validator 206 and/or node 202 (or the owner of the validator 206) by accessing NFT information in a blockchain stored at the blockchain server 208. However, the blockchain obscures the actual owner of the node 202 (or the validator 206) from the backend server 210.

The validator 206 can determine and store performance metrics, associated with the node 202a, when the validator 206 receives signals from the node 202a. The performance metrics can associate the performance information with the NFT and provide the performance and NFT information to the backend server 210. The validator 206 may send the performance information periodically, e.g., every 10 seconds, every minute, etc., to the backend server 210 (through the wireless link to the node 202a). The backend server 210 can evaluate the performance of the node 202a and determine a reward for the owner of the node 202. Then, the backend server 210 can access financial institution information from the blockchain using the NFT information from the validator 206. The reward may be paid to the financial institution without the backend server 210 knowing the identity of the owner of the NFT or the node 202. In this way, the owner of the NFT and owner of the antenna 202a remain anonymous.

A configuration of a first network device or node 202 may be as shown in FIG. 3A. The node 202 may be any RAN, base station, edge computing device, etc., which provides wireless access to a network 202. In one configuration, the node 202 can be a RAN for an 4G LTE cellular network or 5G cellular network. For 4G, the node 202 can be an Evolved Universal Mobile Telecommunications System (UMTS) Terrestrial Radio Access (E-UTRA) Node (eNodeB or eNB). For 5G, the node may be a 5G Node (GNodeB or GnB). In a configuration, the node 202 may include one or more of, but is not limited to, a computing system or base processor 304a, a base station controller 306, a Radio Frequency (RF) front end 302, and/or a power supply 308.

The computing system 304a may include the computing hardware/software, as described in conjunction with FIG. 9. In addition or in the alternative, the computing systems 304a can include a digital signal processor (DSP) 310 and/or an access gateway (AGW) interface 312. The DSP 310 can be any processor hardware and/or software that can process signals to or from the computing system 304a, to or from the gateway 204, and/or to or from the RF front end 302. The DSP 310 can generate various signals, as necessary. For example, control signals or other communications in the network 200 may be generated by the DSP 310. The DSP 310 can be a field programmable gate array (FPGA), an application specific integrated circuit (ASIC), or some other special designed hardware. In other configurations, the DSP 310 is a separate processor from the computing system 304a and may be purchased off-the-shelf. The AGW interface 312 may communicate with the gateway 204 and the network core. The AGW interface 312 can format signals to and from the RF front end 302 to send or receive from the gateway 204.

The power supply 308 can be any hardware or software used to provide power to the node 202. The power supply 308 can include batteries, power converters, connections to the power grid, etc. used to supply and manage power allocation to the node 202.

The RF front end 302 includes any hardware or software for sending RF signals to and receiving RF signals from UE 212, validators 206, or to other nodes 202. The multiplexer 314 may multiplex (or mux) digital signals and output to the combiner 316 or de-multiplex (or de-mux) a digital signal into multiple signals. A combiner 316 can combine or extract analog signals to or from the baseband component. The digital signal extracted from the combiner 316 after analog-to-digital conversion may be sent to the multiplexer 314. The baseband device 318 can modulate or demodulate one or more signals from a baseband signal. The modulated signal may be sent for transmission by an antenna 320. Further, signals received at the antenna 320 may be sent to the baseband 318 for demodulation. For the RF front end 302, the air interface, in the eNB, can use the E-UTRA protocols OFDMA (downlink) and SC-FDMA (uplink) on its LTE-Uu interface.

A base station controller 306 can control the functions of the node 202. In this way, the node 202 can conduct functions without control from the gateway 204 or a central controller. The base station controller 306 can coordinate with other nodes 202b through 202c. This configuration of the controller 306 ensures the nodes 202 function independently as distributed systems. For controller functionality, eNB interfaces may use the System Architecture Evolution (SAE) core (also known as Evolved Packet Core (EPC)) or some other similar architecture. The eNB may use the S1-AP protocol on the S1-MME interface with the Mobility Management Entity (MME) for control plane traffic.

A configuration of a validator 206 may be as shown in FIG. 3B. The validator 206 can include a computing function, system. or processor 304b, which may be similar to that of the node 202. The computing functions 304b may be one or more of the functions in hardware and/or software as described in conjunction with FIG. 9. The computing system 304b may also include an AGW interface 332, which may be the same as or similar to the AGW interface 312, described in conjunction with FIG. 3A.

The computing systems 304b may also communicate with a user interface 333. The user interface 333 can be any type of input device, output device, or display to provide information to a user. In some configurations, the user interface 333 may be a screen or monitor attached to the validator 206. In other arrangements, the user interface 333 may be a series of lights or other visual indicators that provide the status of the validator 206. The user interface 333 can accept input either through buttons, through a mouse, or some other types of input devices.

Computing system 304b may also manage or control a switch 334. The switch 334 may be an electronic switch that can select one of the two or more Subscriber Identity/Identification Module (SIM) cards 324a through 324c. The SIM card 324 may be any type of SIM card for any type or network. Thus, the validator 206 can connect to different types of networks and evaluate those other networks. For example, a first SIM 324a may connect to the network 202. A second SIM card may connect to a different network provider, for example, a Verizon wireless network, a cable internet network, etc. The switch 334 may switch between the SIM cards 324 and the RF front end 326 of the validator 206.

The RF front-end 326 may be an LTE card or other type of electronic RF system. The RF front end 326 can send and receive signals to and through antenna 327. The RF front-end 326 may be controlled by a controller 336, which may communicate with computing system 304b. The controller 336 can be any type of electronic controller for managing the functions of the RF front-end 326.

The computing system 304b may also communicate or be connected with a power supply 330, a Global Positioning System (GPS) system 328, an inertial measurement unit (IMU) 340, and/or a Bluetooth system 338. The power supply 330 can have one or more of the electrical or other control functions for a power supply 330. The power supply 330 may provide battery power or other types of power to the validator 206 components. The GPS 328 may communicate and receive signals from a global positioning satellite, and then resolve those signals into a determined position, which may be provided to the computing system 304b.

The Inertial Measurement Unit (IMU) 340 may provide location information or orientation information to the computing system 304b. As such, the location of the validator 206 may be determined even in areas where the GPS signal from the GPS system 328 is weak or not available. The Bluetooth system 338 allows for Near Field Communication (NFC) with other devices (e.g., UEs) in close physical proximity to the validator 206. The Bluetooth system 338 may operate with the Bluetooth protocol. However, in other configurations, different NFC wireless systems may be used by the validator 206.

FIG. 3C represents a block diagram of representations of processes or other functions that may be executed in hardware and/or software of the servers/devices 202, 206, 210, etc. Processors 304, as described herein, may execute these different processing functions 342-356. In configurations, the processing functions 342-356 may also be executed within the core system 204 or a server 210 or some combination thereof. However, in some other configurations, one or more of these functions 342-356 may be performed at the node 202 (e.g., an edge computing device), either completely or in part.

An NFT processor 342 can create an NFT with a blockchain server 208. The NFT processor 342 can associate the NFT 402 with network hardware, for example, the validator 206 or the node 202. The NFT processor 342 can also provide this identity to the other devices within the network 200 for storage at those devices and for using the NFTs as an identifier for that hardware within the network 200.

The network communication processor 344 can manage communications through the network 200 for this processor 304. The network communication processor 344 can provide control functions with other nodes 202 or with the gateway 204. The network communication processor 344 can send messages or directives to other nodes 202 for switching of traffic patterns or signals, for the signal hopping between cells 106, or for other functions. The blockchain interface 346 interfaces with the blockchain server 208. The blockchain interface 346 can provide access to blockchains 420 and allow for creation of NFTs 402 and/or blockchains 420 within the blockchain server 208.

The performance processor 348 can manage the collection of and/or the interpretation of performance metrics received from network devices 202/206. Performance metrics 466 can be, for example, determined by validators 206 through communications with the nodes 202. This performance metrics information 466 may be provided to determine rewards by the reward processor 350. The rewards processor 350 can determine an amount of incentive award for providing coverage or other action within the network 200. For example, the rewards processor 350 may provide digital currency based on the existence of coverage within a cell 106/108 and/or the provision of a high quality of signal. The rewards processor 350 can also reward other behaviors, for example, as amount of bandwidth provided, the speed provided, or other types of signal metrics that may be measured by the performance processor 348.

The log processor 352 may be able to receive performance metrics and create metric logs 484 with information from validators 206 that are or were communicating with one or more nodes 106. A log processor 352 can extract the data from performance metrics 458 to generate logs 484 and provide the logs 484 to the performance processor 348 or other processors, as necessary.

The cell map processor 354 can logically divide the physical space 102 into the array 104 of cells 106. The logical information may be stored by the cell map processor 354 in a memory or GIS database. The cell map processor 354 can also provide the representation 112 of the apportioned physical space on a user interface 110, as described in conjunction with FIG. 1B. The cell map processor 354 can provide data about the one or more cells 106 to the cell coverage processor 356.

The cell coverage processor 356 can determine whether a cell 106 has network coverage or provides a network access point at the cell 108, as described in conjunction with FIG. 1A. The cell coverage processor 356 can also provide for incentive rewards in the map 112 for providing coverage in the cell 114. For example, the cell coverage processor 356 can determine which cell 126 needs coverage and provide the incentive 446, as described in conjunction in with FIG. 1C.

Another configuration of one or more processors/processes 358-374 that may be executed by processor 304 may be as shown in FIG. 3D. The processor 304 may execute the functions 358-374 in a validator 206 and/or node 202.

A WiFi scanning processor 358 can scan for WiFi signals from one or more nodes 202 in one or more cells 106. The WiFi scanning processor 358 can determine the availability of a network antennae 202 and, optionally, the strength of cellular signal. The availability of the network node 202 may be provided to the modem processor 362. The WiFi scanning processor 358 can also provide any kind of connection information or other data about the available signals to the modem processor 362.

The modem processor 362 may then select which SIM 324 to use to access the available network. The computer processor 304 can send a signal to the switch 334, based on the instructions by the modem processor 362, to select the cell 106. The modem processor 362 manages the control signals to the switch through SIMs 324. The modem processor 362 can change or modify any configurations or other communication signal instructions needed by the SIM 324 to connect to the network 200.

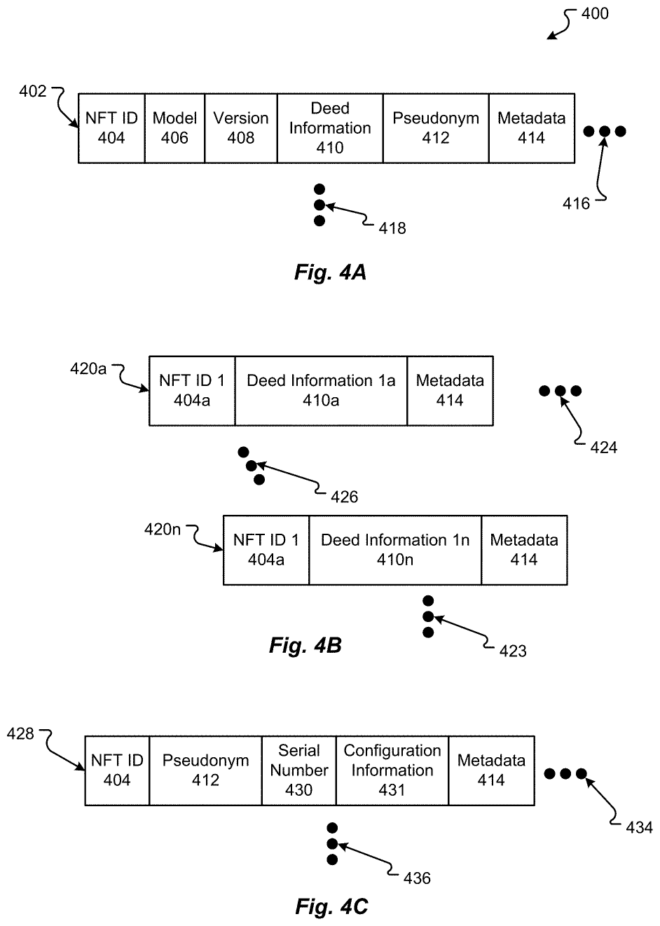

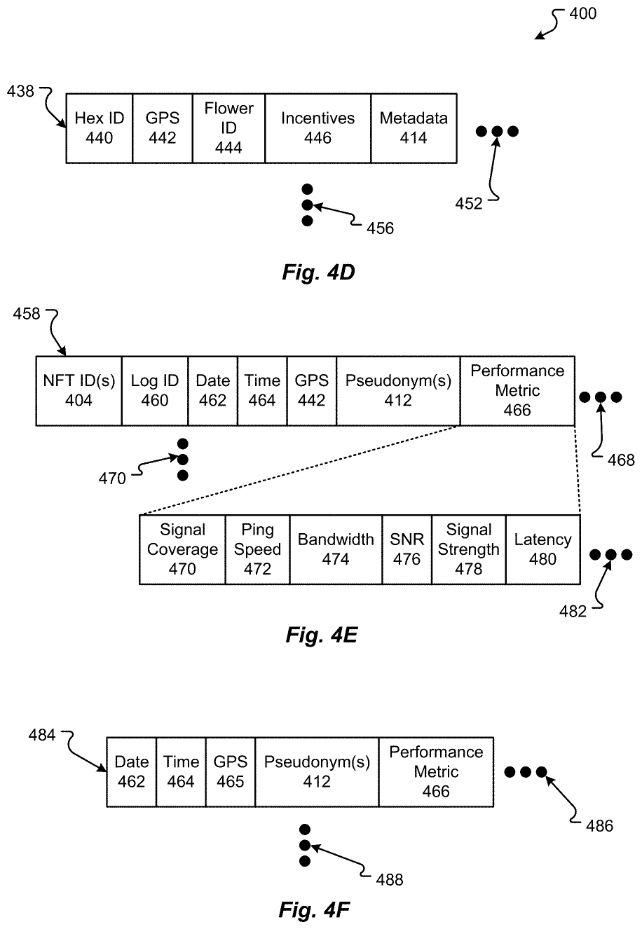

The performance processor 364 may then obtain performance metrics 466 for the first network device 202 or the validator 206. Performance metrics 466 can measure different types of signal information; the performance metrics may be as shown in FIG. 4E. The performance processor 364 can send the information extracted from the modem processor 362, modem scanning processor 366, or other processors to the log processor 368 for writing into a performance metric log 484. An example of the log 484 may be as shown in FIG. 4E.

The anti-gaming processor 360 may receive performance metrics from the performance processor 364. The anti-gaming processor 360 can evaluate the metrics received and various logs 484 from the log processor 368. This information may be evaluated to determine if a validator 206 or a node 202 is sending strange performance data. For example, a node 202 could be physically moved from cell 106 to cell 108. This behavior would appear as odd in the performance metrics 466 and indicate that the owner of that device 202 is trying to manipulate the evaluation to receive more incentives or rewards by appearing to cover more cells than is possible. The anti-gaming processor 360 can determine if gaming is occurring and send a signal to the network server 210 to alert of this type of attempt to receive unearned incentives.

The modem network scanning processor 366 may evaluate other networks by communicating with those networks through other SIMs 324. The modem network scanning processor 366 can, at any location, determine the best network for connecting to based on performance metrics 466. This information may be presented to the log processor 368 to provide to the server 210. As such, other information about various networks available at any location may also be provided to the server 210 for evaluation of other Internet service providers.

The cell map processor 370 can be similar to processor 354 and can evaluate or determine locations for cell 106. The cell map processor 370 can determine which cell 106 the validator 206 is in and also determine the cell ID and other information for the cell 106. Further, the cell map processor 370 can provide the information about the map 112 to user interface for the validator 206. This information may also indicate to the validator 206 the location of the cell 106 from which the validator 206 is receiving signal.

The cell coverage processor 372 can determine whether the network 202 or node 202 is providing coverage in the cell 106. The evaluation can change based on various parameters. For example, the cell 106 may need to provide coverage for a predetermined period of time, for example, 24 hours. Other requirements, e.g., bandwidth, predetermined QOS standards, etc., may need to be met and be determined by the cell coverage processor 372. The information collected by the cell coverage processor 372 can be provided to the log processor 368.

Unlike other network validators, the validator 206 may provide a Bluetooth/WiFi hotspot functionality 374. The Bluetooth/WiFi hotspot functionality 374 allows UE to connect to the validator 206 as a gateway to the network 200 provided by nodes 202. This additional functionality allows the validators 206 to function as a hotspot and validator.

A log processor 368 can generate the logs that provide the performance metrics to the server 210; the performance metrics 466 may be as described in conjunction with FIG. 4E. Each performance metric may have a different data structure 484. The logging of the data may be on a persistent, periodic, and/or consistent basis. The provision of logs to the server 210 may occur periodically. Every second, a new metric may be measured for a node 202 by the validator 206. However, the logs can collect the different data points that may be sent to the server 210.

Configurations of the different data structures that may be stored, retrieved, or created within a datastore 400 and used in the network 200 may be as shown in FIGS. 4A through 4F. The data structure 402 in FIG. 4A may be an NFT that is created by an NFT processor 342 in conjunction with communications to the blockchain server 208. An NFT 402 is a unique digital identifier that cannot be copied, substituted, or subdivided, that is recorded in a blockchain, and that is used to certify authenticity and ownership of a network device. The ownership of an NFT is recorded in the blockchain and can be transferred by the owner, allowing NFTs to be sold and traded. NFTs can be created by the server 210.

The NFT data structure 402 may include one or more of the following, but is not limited to, an NFT identifier (ID) 404, model information 406, version information 408, deed information 410, a pseudonym 412, and/or metadata 414. There may be more or fewer fields than that shown in FIG. 4A, as represented by ellipses 416. Further, each NFT generated may have its own set of data therefore there may be more than just a single NFT created in data set 400, as represented by ellipses 418.

The NFT ID 404 can be any type of digital identifier. For example, the NFT ID 404 (and all other IDs in this disclosure, e.g., hex ID 440, flower ID 444, log ID 460, etc.) can be a numeric, alphanumeric, globally unique identifier (GUID), a hash of information within the data structure, or another type of identifier either provided or extracted from the information in the data structure. The NFT ID 404 can uniquely identify this NFT within the data store 400 and blockchain 420. Model information 406 can include the model or other identifier for the model of the hardware 206/202. The version information 408 can provide a version number of the model 406.

Deed information 410 can include any information provided by the blockchain server 208 or ownership information of the NFT. A pseudonym 412 may be some name used within the network 200 of nodes 202. The pseudonym 412 can be a name that may be publicly used to identify the NFT. Metadata 414 (as with other metadata 414 in the data store 400) can be any other information about the NFT or the data in data structure 402 or other data structure.

An example of a blockchain 420a through 420n may be as shown in FIG. 4B. A blockchain 420 is a type of distributed ledger technology (DLT) that consists of growing lists of records, called blocks, that are securely linked together using cryptography. Each block contains a cryptographic hash of the previous block, a timestamp, and transaction data (generally represented as a Merkle tree, where data nodes are represented by leaves). The timestamp proves that the transaction data existed when the block was created. Since each block contains information about the previous block, the blocks effectively form a chain, with each additional block linking to the ones before it. Consequently, blockchain transactions are irreversible in that, once they are recorded, the data in any given block cannot be altered retroactively without altering all subsequent blocks.

The blockchain 420 can include the NFT ID 404, deed information 410a through 410n, and metadata 414. The blockchain 420 can have more or fewer fields than that shown in FIG. 4B, as represented by ellipses 424. The NFT ID 404, deed information 410, and metadata 414 is the same or similar to the information described in FIG. 4A and will not be described further hereinafter. The owner of the NFT may change over time and thus different blockchain entries 420a-420n may be created, as represented by ellipses 426. As such, each item of deed information 410, within a blockchain entry 420, may be different than those before or after it. There may be more blockchains 420 than that shown in FIG. 4B, as represented by ellipses 423.

An example of a data structure 428 for storing information associated with the NFT and stored in the server 210 database may be as shown in FIG. 4C. The data structure 428 can include the NFT ID 404, the pseudonym 412, a serial number 432, configuration information 431, and/or metadata 414. Data structure 428 may have more or fewer fields than that shown in FIG. 4C, as represented by ellipses 434. Each NFT can have a different data structure 428, as represented by ellipses 436

The serial number 430 may be a serial number of the equipment that a manufacturing entity has assigned to the equipment. Configuration information 431 may be any configuration input associated with the equipment 202/206. Configuration information could be software versions, settings for the device, etc.

An example of cell information may be as shown in data structure 438 of FIG. 4D. Cell information 438 may describe various features or aspects of the cells 106a through 106c. This information 438 can be used to provide or associate incentives with the cell 106 in a display 110. Data structure 438 can include one or more of, but is not limited to, a ID 440, GPS information 442, a flower ID 444, incentives 446, and metadata 414. There may be more or fewer fields in data structure 438, as represented by ellipses 452. Each hex 106 within the array 104 may have a different data structure 438, as represented by ellipses 456.

The hex ID 440 can be any unique identifier for the cell 106. The GPS 442 can be any geospatial data to identify the location of the cell 106. The hex 106 may be part of a larger flower. As shown in FIG. 1A, the cells may be arranged in a larger pattern of several hexes 106, which may be considered the flower. Each flower can have a flower ID 444. Incentive 446 can include any monetary or other type of incentive that may be associated with the cell 106. The incentives may be provided based on network coverage within the cell 106 as determined over time or another achieved event or measure. Any information about the requirements for receiving the incentive and the financial outlay or other type of outlay may be included in the information about the inventive 446.

An example of a performance metric data structure 458 may be as shown in FIG. 4E. The data structure 458 can include one or more of, but is not limited to, the NFT ID 404, a log ID 460, date information 462, time information 464, GPS information 442, the pseudonym 412, and/or performance metrics 466. The data structure 458 can have more or fewer fields than that shown in FIG. 4E, as is represented by the ellipses 468. There may be one or more entries for metrics by each validator, as represented by ellipses 471. Performance metrics 466 can include one or more of, but is not limited to, signal coverage 470, ping speed 472, bandwidth 474, signal-to-noise (SNR) 476, signal strength 478, and/or latency 480. There may be more or fewer performance metrics 466 than that shown in FIG. 4E, as represented by ellipses 482.

The log ID 460 can be any type of identifier for this log entry. The date information 462 indicates the date at which this data structure 458 was created. The time information 464, likewise, can be the time at which the data structure 458 was created.

Performance metrics 466 can indicate whether and how well the node 202 is providing network access. The signal coverage 470 is an indication that the signal exists within the cell 106. Signal coverage may be required over a predetermined amount of time before the signal coverage is indicated in field 470. The ping speed 472 is a speed measurement for a data packet or ping sent from the validator 206 through the network device 202 and back. The bandwidth 474 can be an indication of the amount of bandwidth available from the node 202. The signal-to-noise ratio (SNR) 476 can indicate the strength and quality of a signal from node 202 to the validator 206. SNR 476 can also indicate the amount of interference that may exist in the environment around the antenna 202. A signal strength 478 can be a measure of the strength of the signal, measured in decibels, received at validator 206. The latency 480 can indicate a delay that may exist with communications coming through the node 202.

A log data structure 484 may be as shown in FIG. 4F. The log 484 can contain a series of metrics entries from the data structures 458, stored by the validator 206 and received by the server 210. The log data structure 484 can have more entries than that shown in FIG. 4F, as represented by ellipses 488. The log data structure 484 can include one or more of, but is not limited to, the date 462, time 464, the GPS location information 465, the pseudonym 412, and one more performance metrics 466. The log data structure 484 can include more or fewer fields than that shown in FIG. 4F, as represented by ellipses 486. The fields of the log data structure have all been described previously and will not be described again here.

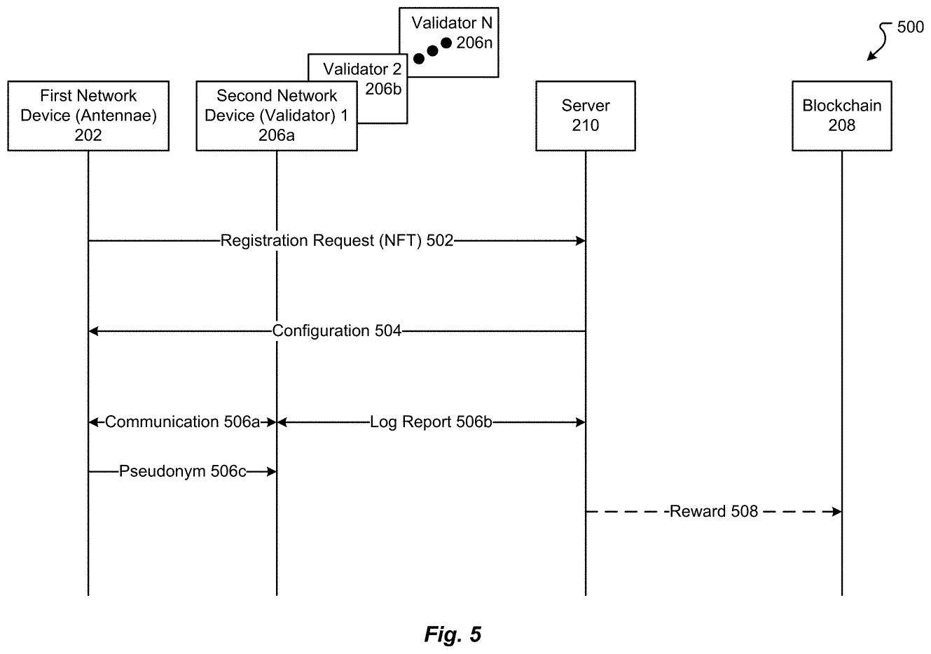

FIG. 5 is a representation of a signaling process 500 as provided between the network devices 202/206, server 210, and/or the blockchain server 208 in accordance with aspects of the present application. The signaling process 500 can include communications between the first network device 202 and the second network device 206, which provides validation data or other performance metrics to the server 210. The server 210 can communicate with the blockchain server 208 before establishing a new node 202 within a cell 106 and before the server 210 may send a first network device 202 to a customer or owner. The blockchain server 208 can provide a NFT 402 and generate a new blockchain entry 420. The NFT 402 can then be stored in the first network device 202. The server 210 can create and associate NFT 402 with the model and version information 406/408.

After installing the first network device 202, the first network device 202 may then establish or connect the first network device 202 to the network 200 and send a registration request 502 to the server 210. The registration request 502 can include the NFT 402 that may have been previously stored in the first network device 202. The server 210 can receive the registration request 502 and establish the data structure 428 for the first network device 202. The server 210 may then create configuration information 431 and determine the serial number 430 and the pseudonym 412, which may be associated in data structure 428. Configuration information 431 may be incorporated in signal 504 along with the pseudonym 412 or other information from the server 210 back to the first network device 202 to configure communications with the network 200 and server 210.

After configuration, the first network device 202 may communicate with a second network device 206 in communication(s) 506a. During these communications, the second network device 206 can obtain performance metrics 466. These performance metrics 466 can be stored in the log entry 458. The information 458 made then be provided in a log signal 506b to be sent back to the server 210 from the validator 206. The performance metrics allow the server 210 to determine performance of the first network device 202. Some configurations or communication processes can send the NFT ID 404 or pseudonym 412 to the second network device 206 in signal 506c to identify the first network device 202. Thus, the NFT information can identify the first network device 202 without the validator 206 actually knowing who the owner or operator of the first network device 202 is.

Further, the server 210 can identify the first network device 202 and determine any reward or incentive that is earned by the first network device 202. The server 210 can pay the reward by searching, with signal(s) 508, in the blockchain 420, for the NFT ID 404. Then, the server 210 can extract deed information 410n from the blockchain 420, the server 210 can then send a financial reward (e.g., digital currency) to the financial institution of the owner listed in the deed information 410n of the blockchain 420, in signaler 508. If the owner of the NFT has anonymized their information in the deed information 410, the reward will be sent anonymously to the owner of the NFT 402 (which is the owner of the first network device 202).

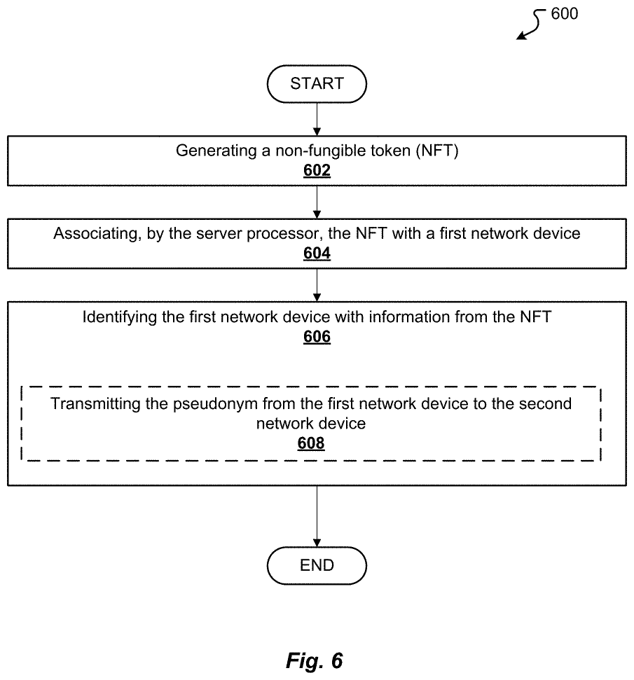

FIG. 6 is a representation of a method 600 for associating an NFT with a physical network device in accordance with embodiments of the present disclosure. A general order for the steps of the method 600 is shown in FIG. 6. The method 600 can include more or fewer steps or can arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an ASIC, a FPGA, a System-On-Chip (SOC), or other hardware device. Hereinafter, the method 600 shall be explained with reference to the systems, components, devices, modules, software, signals, data structures, interfaces, methods, etc. described herein.

The server 210 may communicate with the blockchain server 208 to generate an NFT, in stage 602. The server 210 may send a message to the blockchain server 208 to generate the NFT. Thus, interaction of the blockchain server 208 and the server 210 can generate the information for data structure 402. This information 402 may then be sent to and stored at the server 210.

The server 210 can then associate the NFT 402 with a first network device 202, in stage 604. The server 210 can associate the NFT 402 with the first network device 202 by storing the NFT in the memory of the first network device 202 before the first network device 202 is deployed. The processor 304 of the node 202, can store the NFT 402 within memory 920, as provided in FIG. 9. In at least some configurations, the storage of the NFT 402 may be completed or stored by a distributor or manufacturer of the node 202 or through other processes before sending the first network device 202 to the person deploying the antenna 202, in the stage 604.

After installing the first network device 202, the first network device 202 can signal the server 210 in a registration request 502 including the NFT 402. The server 210 may then associate the NFT 402, with a serial number 430, device configuration information 431, and/or the pseudonym 412 in the NFT 402, in stage 604.

At some time thereinafter, the first network device 202 can send the pseudonym 412, in a signal 506, which may be sent to the second network device 204, in stage 606. The registration request 502 can include at least some information from the NFT 402.

In at least some configurations, the pseudonym 412 is sent when the first network device 202 communicates with the second network device 206 to identify the first network device 202. The first network device 202 can transmit the pseudonym 412 to the second network device 206, in optional stage 608. This stage is optional as the pseudonym 412 may not be the only information that can identify the first network device 202. The second network device 206 can then identify the first network device 202 with the pseudonym 412 or other information from the NFT 402, in stage 606.

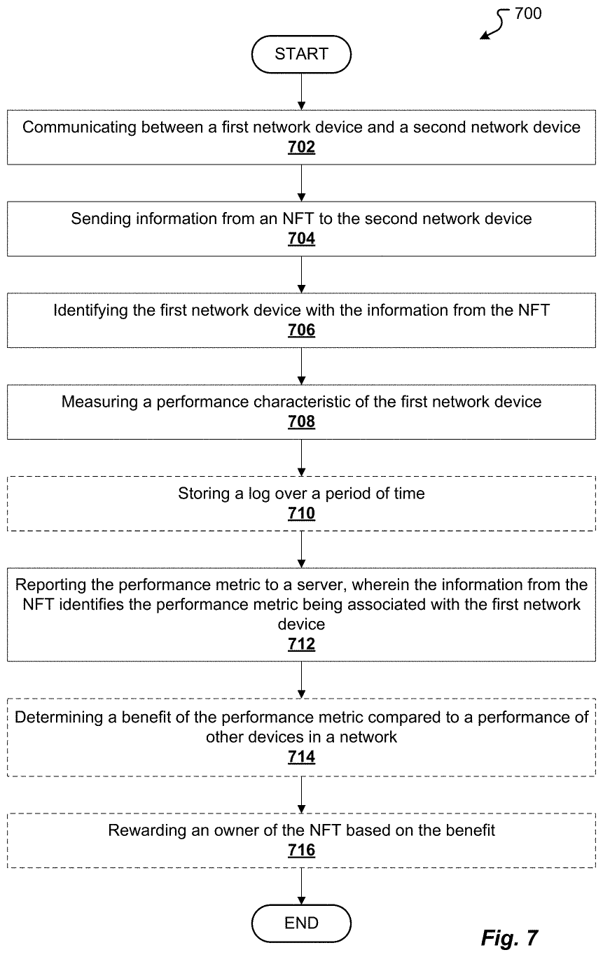

FIG. 7 represent a method for rewarding the performance of a first network device 202 using crypto-based rewards. A general order for the steps of the method 700 is shown in FIG. 7. The method 700 can include more or fewer steps or can arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, an ASIC, a FPGA, a SOC, or other hardware device. Hereinafter, the method 700 shall be explained with reference to the systems, components, devices, modules, software, signals, data structures, interfaces, methods, etc. described herein.

A first network device 202 can communicate with a second network device 206, in stage 702. The validator 206 may physically enter a cell 106 and communicate with the first network device 202. Communications may be established through normal network protocols. After establishing communications between the first network device 202 and the second network device 206, the first network device 202 can send information from an NFT 402 to the second network device 206, in stage 704. Any information from the NFT 402 that may identify the first network device 202 may be sent to the validator 206. In at least some configurations, the pseudonym 412, of the first network device 202, can be sent to the second network device 206.

The second network device 206 can identify the first network device 202 from this NFT information, in stage 706. The second network device 206 does not receive the name or identity of the owner of the first network device 202. As such, the pseudonym 412 or information from the NFT 402 anonymizes the interaction between the first network device 202 and second network device 206.

During the communication(s) 506, the second network device 206 may measure performance characteristic(s) or performance metric(s) 466 during the communications, in stage 708. The performance characteristic can be any of the performance metrics 466 or other information that might be gleaned from the communication(s) 506. This information may be stored in a log entry 458. One or more of these log entries 458 may be stored by the second network device 206 in a log 484 over some amount of time, in stage 710. For example, a log entry 458 may be made every second, and the log may be stored every 30 seconds. Other different configurations of the log entries 458 and logs 484 are possible. After recording the log 484, the second network device 206 can report the performance metric(s) to the server 210, in stage 712. The second network device 206 can send the log 484 or one or more of the entries 458 to the server 210. Within these communications will be data structures 484/458 or portions thereof that include information from the communication 506 and is an anonymized identity for the first network device 202. The identity includes information within the NFT 402, for example, an NFT ID 404 or a pseudonym 412. The reporting can occur periodically, in stage 712.

Based on the performance metric 466, the server 210 can determine the benefit of the first network device 202 based on the performance metric compared to the performance of other similar devices within the network 200, in optional stage 712. The server 210 can have a predetermined algorithm for determining the benefit provided by the first network device 202. For example, the first network device 202 may provide coverage within more than one cell 106. In other configurations, the bandwidth 474 provided by the first network device 202 may be measured. Whatever performance measure is determined, that amount of production or availability of bandwidth or network coverage may be measured and compared to other networked devices 202. Based on this comparison, an amount of a reward can be sent to the owner of the network device 20, in optional stage 716.

The server 210 may reward the owner of the NFT based on the benefit determined in stage 714, in stage 716. The reward can be an amount of digital currency or some other type of reward. The server 210 can use the NFT information provided in performance metrics 458 or 484 to access the blockchain 420 stored at the blockchain server 208. The retrieved information can include the deed information 410, which identifies the owner or the owner's financial institution. There may be a pointer to some other server or place to provide digital currency. The server 210 may then send the award to the owner of the first network device 202 as identified in the blockchains 208.

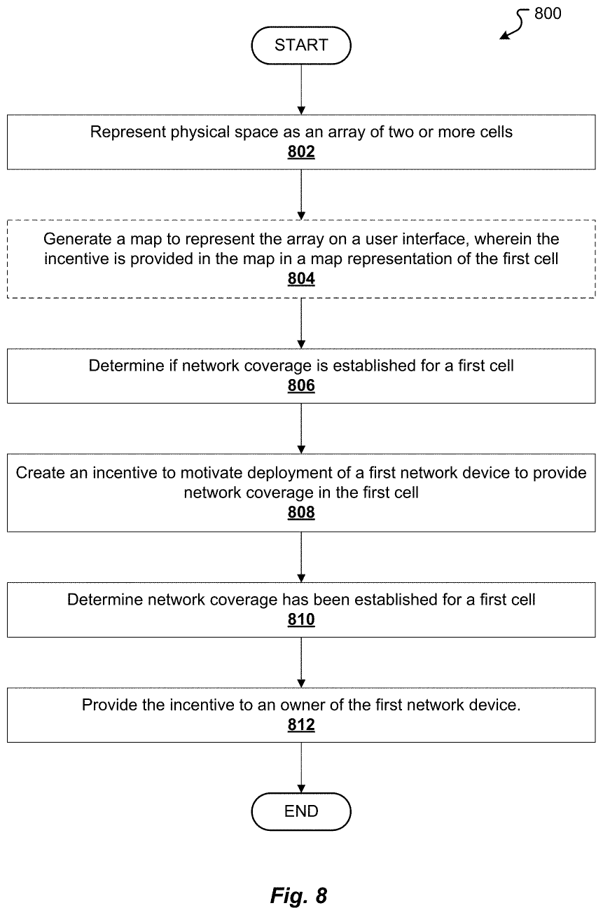

FIG. 8 depicts a method for motivating network coverage in a cell 106 of the array 104 in accordance with embodiments of the present disclosure. A general order for the steps of the method 800 is shown in FIG. 8. The method 800 can include more or fewer steps or can arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, an ASIC, a FPGA, a SOC, or other hardware device. Hereinafter, the method 800 shall be explained with reference to the systems, components, devices, modules, software, signals, data structures, interfaces, methods, etc. described herein.

A server 210 can represent physical space 102 as an array 104 of two or more cells 106/108, in stage 802. The server 210 can generate geospatially-defined cells 106/108 in an array 104, with a hex pattern that proportions physical space into two or more cells 106. The geospatial information including, for example, the center of the cell 106 and the cell perimeter and orientation may be determined. This information may be stored in a database as cell information 438. The data structure 438 may be part of a GIS database or some other database storing geospatial information. As an optional stage 804, the server 210 may generate a map 112 to represent the array 104 on the user interface 110 of a computing system. The map 112 may include a visualization(s) of the information defining the physical space 102.

The visualization, in the user interface 110, can include selectable items, for example, graphical elements (e.g., selectable cells 114 that may be selected using a user input device that controls a cursor or some other user interface representation 118/116. On selecting a cell 114, using the user interface input device, the user interface 110 can change to show information about the cell 114, as described in conjunction with FIG. 1C. Included within this representation may be an incentive 122 that is provided in the map as a map representation of the first cell 114. The incentive 122 can be selected through user input to have displayed information about the incentive that can be obtained by providing network coverage in that cell 114 in physical space.

The user interface 110 can also represent whether there is network coverage within any cell 106. The server 210 for can determine if network coverage is established for a first cell 106, in stage 806. The server 210 can analyze performance metrics received from the validator 206 to the determine if network coverage has been provided for a cell 106. Cells with network coverage made have a different visual indicia (e.g., color, shading, fill, etc.) than those cells without network coverage, as shown in FIGS. 1A and 1B.

If no network coverage has been established for a first cell 106, the server 210 can create an incentive to motivate deployment of a first network device 202 within that cell 106/108 to provide network coverage, in stage 808. The server 210 can create incentive information 446 and associate that incentive information 446 with the cell data structure 438. Further, the server 210 can create the visual representation of the incentive 122, which provides information from data structure 446 to a user. This motivation can be an amount of digital currency or some other reward that may be provided for providing network coverage over some amount of time, for example, 30 days. The server 210 might then analyze returns from the validator(s) 206 to determine if network coverage has been established for that cell 106, in stage 810.

The server 210 receives performance metrics for the cell 106 from validators 206 that enter the cell 106. The network signal coverage 470 may have been determined and returned for the cell 106, in stage 810. If the network coverage is established for that cell 106/108 that meet the requirements for the incentive in data 446, the server 210 can provide the incentive to the owner of the first network device 202. As described in conjunction with FIG. 7, the server 210 can use the NFT information provided by the validator 206 in data structures 458, 484 to access the blockchain 420 stored at the blockchain server 208. From deed information, the server 210 can determine an owner of the first network device 202 and send the reward or digital currency in the incentive to the owner based on blockchain information 420 to provide the incentive to the owner of the first network device 202, in stage 812.

FIG. 9 illustrates one configuration of a computer system 900 upon which the computing functions, processors, computing devices, or other systems or components described above may be deployed or executed. The computer system 900 is shown comprising hardware elements that may be electrically coupled via a bus 902. The hardware elements may include one or more central processing units (CPUs) 904; one or more input devices 906 (e.g., a mouse, a keyboard, etc.); and one or more output devices 908 (e.g., a display device, a printer, etc.). The computer system 900 may also include one or more storage devices 910. By way of example, storage device(s) 910 may be disk drives, optical storage devices, solid-state storage devices such as a random-access memory (“RAM”) and/or a read-only memory (“ROM”), which can be programmable, flash-updatable and/or the like.

The computer system 900 may additionally include a computer-readable storage media/reader 912; a communications system 914 (e.g., a modem, a network card (wireless or wired), an infra-red communication device, etc.); and working memory 920, which may include RAM and ROM devices as described above. The computer system 900 may also include a processing acceleration unit 916, which can include a digital signal processor (DSP), a special-purpose processor, and/or the like.

The computer-readable storage media/reader 912 can further be connected to a computer-readable storage medium, together (and, optionally, in combination with storage device(s) 910) comprehensively representing remote, local, fixed, and/or removable storage devices plus storage media for temporarily and/or more permanently containing computer-readable information. The communications system 914 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information.

The computer system 900 may also comprise software elements, shown as being currently located within a working memory 920, including an operating system 918 and/or other code 922. It should be appreciated that alternate embodiments of a computer system 900 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 904 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core® family of processors, the Intel® Xeon® family of processors, the Intel® Atom® family of processors, the Intel Itanium® family of processors, Intel® Core® i5-4670K and i7-4770K 22 nm Haswell, Intel® Core® i5-3570K 22 nm Ivy Bridge, the AMD® FX® family of processors, AMD® FX-4300, FX-6300, and FX-8350 32 nm Vishera, AMD® Kaveri processors, Texas Instruments® Jacinto C6000® automotive infotainment processors, Texas Instruments® OMAP® automotive-grade mobile processors, ARM® Cortex®-M processors, ARM®. Cortex-A and ARM926EJ-S® processors, other industry-equivalent processors, and may perform computational functions using any known or future-developed standard, instruction set, libraries, and/or architecture.

Any of the steps, functions, and operations discussed herein can be performed, either separately or as a group of steps, functions, and operations, continuously, periodically, and automatically.

The exemplary systems and methods of this disclosure have been described in relation to vehicle systems and vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a Local Area Network (LAN) and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a Private Branch Exchange (PBX) and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data, instructions, etc., to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), FPGA, Programmable Array Logic (PAL), special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or Common Gateway Interface (CGI) script, as a resource residing on a server or computer workstation that may be executed either remotely or locally, e.g., cloud computing or remote computing, as a routine embedded in a dedicated measurement system, system component, or the like. The system can also be implemented by physically incorporating the system and/or method into a software and/or hardware system. The software may also include instruction sets, data, interface renderings, etc., that are stored, either permanently, on a computer-readable storage medium, or temporarily (i.e., for a period of time before being erased or written over, for example, in a buffer), on a computer-readable storage medium.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium (also referred to as a “computer-readable medium”) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (Erasable Programmable Read-Only Memory (EPROM) or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a portion or an entire program, either permanently or temporarily, for use by or in connection with an instruction execution system, apparatus, processor, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation or technique.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

An aspect of the present disclosure comprises a method comprising: generating, by a server processor, a non-fungible token (NFT); associating, by the server processor, the NFT with a first network device; and identifying, by a second network device, the first network device with information from the NFT.

Any of the one or more above aspects, wherein the NFT comprises one or more of an identifier, a pseudonym, and/or deed information.

Any of the one or more above aspects, wherein the NFT further comprises model or version information for the first network device.

Any of the one or more above aspects, wherein the NFT is stored at the first network device.

Any of the one or more above aspects, further comprising transmitting the pseudonym from the first network device to the second network device.

Any of the one or more above aspects, wherein the first network device is a cellular antenna.

Any of the one or more above aspects, wherein the second network device is a network validator.

Any of the one or more above aspects, wherein the network validator is a stand-alone device or an application executing on a mobile device.

Any of the one or more above aspects, wherein an identity of an owner of the first network device is unknown to the second network device.

Any of the one or more above aspects, wherein an identity of the owner of the first network device is stored in a block chain.

Another aspect of the present disclosure comprises a server comprising: a memory; a processor in communication with the memory, the processor configured to execute a method, the method comprising: generating a non-fungible token (NFT); associating the NFT with a first network device; storing the NFT in the memory; and providing the NFT to the first network device to identify, by a second network device, the first network device with information from the NFT.

Any of the one or more above aspects, wherein the NFT comprises one or more of an identifier, a pseudonym, and/or deed information.

Any of the one or more above aspects, wherein the NFT further comprises model or version information for the first network device.

Any of the one or more above aspects, wherein the NFT is also stored at the first network device.

Any of the one or more above aspects, the method further comprising receiving, from the second network device, the pseudonym to identify information about the first network device provided by the second network device.

Any of the one or more above aspects, wherein the first network device is a cellular antenna.

Any of the one or more above aspects, wherein the second network device is a network validator.

Another aspect of the present disclosure comprises a computer readable medium having stored thereon instructions executable by a processor of a first network device, which when executed by the processor cause the processor to execute a method, the method comprising: receiving a non-fungible token (NFT) generated by a server, the NFT associated with the first network device; storing the NFT in memory of the first network device; and providing information from the NFT to a second network device to identify the first network device.

Any of the one or more above aspects, wherein the NFT comprises one or more of an identifier, a pseudonym, deed information, model information, and/or version information for the first network device.

Any of the one or more above aspects, wherein the first network device is a cellular antenna, and wherein the second network device is a network validator.

Another aspect of the present disclosure comprises a method comprising: a first network device communicating with a second network device; the first network device sending information from an NFT to the second network device; identifying, by the second network device, the first network device with the information from the NFT; the second network device measuring a performance characteristic of the first network device; and reporting, by the second network device, the performance metric to a server, wherein the information from the NFT identifies the performance metric being associated with the first network device.

Any of the one or more above aspects, wherein the information from the NFT comprises one or more of an identifier, a pseudonym, deed information, model information, and/or version information for the first network device.

Any of the one or more above aspects, wherein the performance metric is one or more of a signal coverage of an area, a ping speed, a bandwidth provided, a signal-to-noise ratio, a signal strength, and/or a latency.

Any of the one or more above aspects, further comprising storing, by the second network device, a log over a period of time.

Any of the one or more above aspects, wherein the performance metric is stored periodically in the log during the period of time.

Any of the one or more above aspects, further comprising determining, by the server, a benefit of the performance metric compared to a performance of other devices in a network.

Any of the one or more above aspects, further comprising rewarding an owner of the NFT based on the benefit.

Any of the one or more above aspects, wherein a reward for the benefit is an amount of digital currency awarded to the owner of the NFT.

Another aspect of the present disclosure comprises a server comprising: a memory; a processor in communication with the memory, the processor configured to execute a method, the method comprising: receiving a communication, about a first network device, from a second network device; in the communication, receiving information from an NFT associated with the first network device; identifying the first network device with the information from the NFT; in the communication, receiving a measurement of a performance characteristic of the first network device; and reporting the performance metric to a server, wherein the information from the NFT identifies the performance metric being associated with the other network device.

Any of the one or more above aspects, wherein the information from the NFT comprises one or more of an identifier, a pseudonym, deed information, model information, and/or version information for the first network device.

Any of the one or more above aspects, wherein the performance metric is one or more of a signal coverage of an area, a ping speed, a bandwidth provided, a signal-to-noise ratio, a signal strength, and/or a latency.

Any of the one or more above aspects, wherein the communication comprises a log of the performance metric stored over a period of time by the second network device.

Any of the one or more above aspects, the method further comprising determining a benefit of the performance metric compared to a performance of other devices in a network.

Any of the one or more above aspects, further comprising rewarding an owner of the NFT based on the benefit.

Any of the one or more above aspects, wherein a reward for the benefit is an amount of digital currency awarded to the owner of the NFT.

Another aspect of the present disclosure comprises a computer readable medium having stored thereon instructions executable by a processor of a first network device, which when executed by the processor cause the processor to execute a method, the method comprising: receiving a communication from another network device; in the communication, receiving information from an NFT associated with the other network device; identifying the other network device with the information from the NFT; measuring a performance characteristic of the other network device; and reporting the performance metric to a server, wherein the information from the NFT identifies the performance metric being associated with the other network device.

Any of the one or more above aspects, wherein the information from the NFT comprises one or more of an identifier, a pseudonym, deed information, model information, and/or version information for the first computer readable medium.

Any of the one or more above aspects, wherein the performance metric is one or more of a signal coverage of an area, a ping speed, a bandwidth provided, a signal-to-noise ratio, a signal strength, and/or a latency.

Any of the one or more above aspects, the method further comprising storing, over a period of time, a log of the performance metric, wherein the performance metric is stored periodically in the log during the period of time.

Any of the one or more above aspects, the method further comprising sending the log to the server periodically.

Another aspect of the present disclosure comprises a method comprising: representing physical space as an array of two or more cells; determining if network coverage is established for a first cell; creating an incentive to motivate deployment of a first network device to provide network coverage in the first cell; determining network coverage has been established for a first cell; and providing the incentive to an owner of the first network device.

Any of the one or more above aspects, wherein each cell has a hexagonal shape.

Any of the one or more above aspects, wherein the array forms a honeycomb shape.

Any of the one or more above aspects, further comprising generating a map to represent the array on a user interface.

Any of the one or more above aspects, wherein the incentive is provided in the map in a map representation of the first cell.

Any of the one or more above aspects, wherein determining network coverage comprises a second network device communicating with the first network device while the second network device is located in the first cell.

Any of the one or more above aspects, wherein the network coverage is determined for the first network device periodically during a period of time.

Any of the one or more above aspects, wherein the incentive is provided when the network coverage covers the period of time.

Any of the one or more above aspects, wherein the incentive is a payment of a digital currency to the owner of a non-fungible token (NFT) associated with the first network device.

Another aspect of the present disclosure comprises a server comprising: a memory; a processor in communication with the memory, the processor configured to execute a method, the method comprising: representing physical space as an array of two or more cells; determining if network coverage is established for a first cell; creating an incentive to motivate deployment of a first network device to provide network coverage in the first cell; determining network coverage has been established for a first cell; and providing the incentive to an owner of the first network device.

Any of the one or more above aspects, wherein each cell has a hexagonal shape and wherein the array forms a honeycomb shape.

Any of the one or more above aspects, further comprising generating a map to represent the array on a user interface, wherein the incentive is provided in the map in a map representation of the first cell.

Any of the one or more above aspects, wherein determining network coverage comprises a second network device communicating with the first network device while the second network device is located in the first cell.

Any of the one or more above aspects, wherein the network coverage is determined for the first network device periodically during a period of time and wherein the incentive is provided when the network coverage covers the period of time.

Any of the one or more above aspects, wherein the incentive is a payment of a digital currency to the owner of a non-fungible token (NFT) associated with the first network device.

Another aspect of the present disclosure comprises a computer readable medium having stored thereon instructions executable by a processor of a second network device, which when executed by the processor cause the processor to execute a method, the method comprising: communicating with a first network device located in a first cell of an array of two or more cells; determining if network coverage is established, by a first network device, for a first cell, wherein an incentive motivates deployment of the first network device to provide network coverage in the first cell; and sending a log describing the network coverage to a server, wherein the server provides the incentive to an owner of the first network device.

Any of the one or more above aspects, wherein each cell has a hexagonal shape and wherein the array forms a honeycomb shape.

Any of the one or more above aspects, wherein the second network device records a GPS signal received when communicating with the first network device and reports the GPS signal to the server.

Any of the one or more above aspects, wherein the network coverage is determined for the first network device periodically during a period of time and wherein the incentive is provided when the network coverage covers the period of time.

Any of the one or more above aspects, wherein the incentive is a payment of a digital currency to the owner of a non-fungible token (NFT) associated with the first network device.

What is claimed is:

1. A method comprising:
generating, by a server processor, a non-fungible token (NFT);
associating, by the server processor, the NFT with a first network device; and
identifying, by a second network device, the first network device with information from the NFT.

2. The method of claim 1, wherein the NFT comprises one or more of an identifier, a pseudonym, and/or deed information.

3. The method of claim 2, wherein the NFT further comprises model or version information for the first network device.

4. The method of claim 3, wherein the NFT is stored at the first network device.

5. The method of claim 4, further comprising transmitting the pseudonym from the first network device to the second network device.

6. The method of claim 5, wherein the first network device is a cellular antenna.

7. The method of claim 6, wherein the second network device is a network validator.

8. The method of claim 7, wherein the network validator is a stand-alone device or an application executing on a mobile device.

9. The method of claim 8, wherein an identity of an owner of the first network device is unknown to the second network device.

10. The method of claim 9, wherein an identity of the owner of the first network device is stored in a block chain.

11. A server comprising:
a memory;
a processor in communication with the memory, the processor configured to execute a method, the method comprising:
generating a non-fungible token (NFT);
associating the NFT with a first network device;
storing the NFT in the memory; and
providing the NFT to the first network device to identify, by a second network device, the first network device with information from the NFT.

12. The server of claim 11, wherein the NFT comprises one or more of an identifier, a pseudonym, and/or deed information.

13. The server of claim 12, wherein the NFT further comprises model or version information for the first network device.

14. The server of claim 11, wherein the NFT is also stored at the first network device.

15. The server of claim 11, the method further comprising receiving, from the second network device, the pseudonym to identify information about the first network device provided by the second network device.

16. The server of claim 11, wherein the first network device is a cellular antenna.

17. The server of claim 11, wherein the second network device is a network validator.

18. A computer readable medium having stored thereon instructions executable by a processor of a first network device, which when executed by the processor cause the processor to execute a method, the method comprising:
receiving a non-fungible token (NFT) generated by a server, the NFT associated with the first network device;
storing the NFT in memory of the first network device; and
providing information from the NFT to a second network device to identify the first network device.

19. The computer readable medium of claim 18, wherein the NFT comprises one or more of an identifier, a pseudonym, deed information, model information, and/or version information for the first network device.

20. The computer readable medium of claim 19, wherein the first network device is a cellular antenna, and wherein the second network device is a network validator.
